(19) United States
(12) Patent Application Publication
(10) Pub. No.: US 2012/0281809 A1
(43) Pub. Date: Nov. 8, 2012

(54) INDICATOR UNIT

(76) Inventor: Rainer Graumann, Hoechstadt (DE)

(21) Appl. No.: 13/464,113

(22) Filed: May 4, 2012

(30) Foreign Application Priority Data
May 6, 2011 (DE) 10 2011 075 435.0

(51) Int. Cl. G01N 23/04

(52) U.S. Cl. 378/62

(57) ABSTRACT

In a method and device to visually indicate a marking location on a patient, an x-ray source generates an x-ray image in which the marking location is indicated. An optical source that emits a light beam has a coordinate system associated therewith, and a computerized coordinate transformation unit automatically determines coordinates of the optical source, in the coordinate system, that cause the light beam emitted thereby to pass through the same marking position indicated in the x-ray image, through which an x-ray beam emitted by the x-ray source also proceeds.

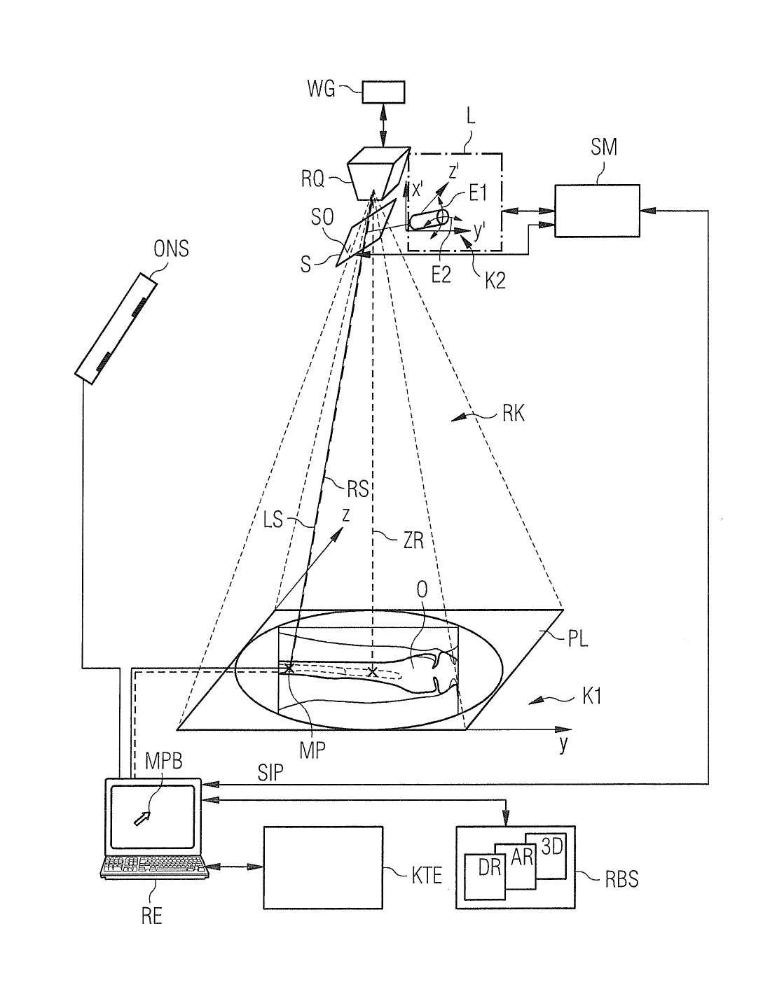

### BACKGROUND OF THE INVENTION

1. Field of the Invention

The present invention concerns an indicator unit that is suitable to provide a visual indication of a location at which a medical procedure is to be implemented.

2. Description of the Prior Art

In image-assisted surgery and therapy, x-ray C-arms for acquisition of x-ray images are used in order to execute surgical procedures and to implement or modify intra-operative therapy plans. With the use of x-ray images in advance of an implant integration, the surgeon can detect fracture behavior in the bone and select (and if necessary adapt) implants accordingly. Moreover, x-ray acquisitions for continuous monitoring can be applied during an implant placement. However, x-ray acquisitions for planning and monitoring as well as during a surgical procedure have the disadvantage that the patient is exposed to x-ray radiation at every x-ray acquisition.

### SUMMARY OF THE INVENTION

An object of the present invention is to provide an indicator unit for placement of instruments in procedures of the above type.

In the device and the associated method, marking locations that can be predetermined manually and/or that can be detected by optical/electromagnetic navigation systems are indicated in x-ray images with a light beam toward the subject, the light beam being emitted by an optical source.

The device for alignment of the optical source connected with an x-ray unit has a coordinate transformation unit. After specifying a marking location, the coordinates of the optical source to be aligned are determined in order to cause the light beam emitted by the optical source to correspond with an x-ray beam traveling through the marking location.

In one embodiment, a deflection unit is provided that controllably deflects the light beam, and the optical source and/or the deflection unit arranged in the x-ray cone are controlled by a control unit such that the alignment of the light beam corresponds to the x-ray beam traveling through the marking location. The optical source can be designed as a laser unit that emits a laser beam as the light beam.

In the method to align an optical source connected with an x-ray unit, after specification of a marking location, the alignment of the light beam or laser beam of the optical source takes place so that the light beam or laser beam corresponds to an x-ray beam from the x-ray unit travels through the marking location.

The invention has the advantage that with it a surgeon can implement implant positionings and implant attachments with targeted precision, and thus repeat x-ray acquisitions during the positioning can be foregone.

The invention also has the advantage that its use requires only the smallest slice incisions in the region of the procedure to be made on the patient in order to introduce the implant.

The invention has the further advantage that precisely accurate alignment specifications for surgical tools for attachment of the implant are displayed or provided to the surgeon.

The invention also has the advantage that the attachment points for an implant that are established during a preoperative phase can be transferred directly to the patient.

The invention has the advantage that the course of an incision in the tissue of the patient can be displayed corresponding to a preoperative planning.

### BRIEF DESCRIPTION OF THE DRAWING

The single FIGURE is a schematic illustration of an exemplary embodiment of an indicator unit constructed and operating in accordance with the present invention.

### DESCRIPTION OF THE PREFERRED EMBODIMENTS

The drawing schematically shows an embodiment of an x-ray imaging system according to the invention. A deflection unit S of the system is integrated into an x-ray source RQ of the x-ray system. The x-ray source RQ emits an x-ray beam and the deflection unit S deflects a light beam or laser beam LS emitted by an optical source L onto a placement surface PL. The x-ray source RQ can be mounted on an x-ray C-arm. The deflection unit S, for example a mirror, is permeable to x-rays and is arranged in the x-ray cone RK of the x-ray source RQ. Visible and/or infrared light is entirely deflected by the mirror that forms the deflection unit S. The optical source L, such as a power LED or a laser, is arranged in immediate proximity to the deflection unit S and the x-ray source RQ. The optical source L is aligned with respect to the deflection unit S so that a light beam or infrared light LS emanating from the optical source L travels exactly to the same point as an x-ray beam RS emanating from the x-ray source RQ. A first coordinate system K1 is associated with the placement surface or patient bed PL. A second coordinate system K2 is associated with the laser L arranged in immediate proximity to the deflection unit S.

At the x-ray C-arm, the deflection unit S, which is x-ray-transparent is introduced into the beam path of the x-ray source RQ at the output side of said x-ray source RQ. This deflection unit S reflects the light beam LS emanating from the optical source L. The deflection unit (mirror) S is introduced into the x-ray cone RK emitted by the x-ray source RQ such that it is arranged at approximately 45 degrees relative to the central ray ZR of the x-ray cone RK. When the deflection unit S is formed by a mirror, if the distance between the light aperture and mirror surface SO of the mirror corresponds to the distance of the x-ray focus of the x-ray source RQ from the mirror surface SO, the light beam LS travels analogous to the respective x-ray beam from the x-ray source. The optical source L, a laser, for example, can be used virtually with this alignment of the mirror of the deflection unit S relative to the x-ray focus point. The laser can be tilted in at least one first plane E1 and one second plane E2 within the second coordinate system K2, wherein the position of the focus point is not varied upon rotation of the laser. The light source L can be aligned with regard to the described arrangement such that it reaches every point of the x-ray image corresponding to the x-ray beam R emitted by the x-ray source. In one embodiment, the mirror of the deflection unit S can be rotated and tilted instead of alignment of the optical source L.

The subject matter of the invention significantly facilitates the work for the surgeon, for example for the introduction of a locking element into a marking pin. Given the use of the described arrangement, the surgeon aligns the x-ray device such that, among other things, a defined channel of the marking pin for a locking element is visible with the x-ray exposure. In a continuative embodiment, the x-ray device is aligned such that the locking channel in the marking pin is depicted in the x-ray image without wall portions of the channel. The exact penetration of a locking channel can also be determined in the x-ray image by the detection of the entrance and exit of the locking element channel. The alignment of a penetration (incision) can likewise be displayed by linking the digital data and the alignment of the marking pin. In a digital x-ray image DR, for example, the surgeon marks the marking location MP (in particular the middle point) of the channel. In a further embodiment, the middle point MP could be determined by means of associated evaluation units via an optical navigation system ONS with optical markers, or via the existing x-ray image with x-ray markers. The marking point or points MP can also be determined in a computer RE (only schematically depicted here) on a monitor unit associated with the computer RE at which the x-ray image is simultaneously displayed. The position data provided with the marking point MP for a passage in the marking pin are transferred to the coordinate system of the optical source L via the marked coordinates in the x-ray image and produce the data for the attitude and orientation of the optical source L by means of the control unit SM. The optical source L is aligned on the deflection unit S corresponding to the transformation data. In one embodiment, a combined alignment of the optical source L with the deflection unit S (or only an alignment of the deflection unit S) can take place. A point or line that is preoperatively marked in the digital/analog x-ray image BR, AR or a 3D x-ray image, is depicted on the patient via the light beam or the infrared light LS of the optical source L. A centrally situated bore axis of a locking channel of the marking pin lies along the light beam LS of the optical source L. After a small slice incision made by the surgeon, the point is marked on the bone. Access to the locking channel of the marking pin is achieved by drilling through the bone. To implement the drilling, the tip of the drill is set at the point on the bone that is identified by the light beam LS, and the drilling machine is aligned such that the light beam LS falls at a point of the bracket of the drilling machine that lies precisely on the continuing axis of the drill of said drilling machine. The drilling machine is then aligned so that the axis of the drill lies exactly along the centrally situated axis of the locking hole.

The invention has the advantage that the position of the borehole and the alignment of the bore to be implemented are visually displayed to the surgeon in a time-optimized manner without additional x-ray radiation for the patient. The drill is then exactly aligned with the light beam when said light beam LS coincides with the axis that the drill follows.

In a further embodiment, the optical source L arranged on the C-arm can be a laser targeting system in an intraoperative 3D imaging such that anatomical points or regions are marked in a 3D data set and are transferred into the 2D x-ray image upon which the 3D data set is based. The digital x-ray images DR, digitized analog x-ray images AR and the 3D x-ray images can be stored in an x-ray image data memory RBS. The markings in the 2D x-ray image are then converted for the adjustment of the laser targeting system via the coordinate transformation unit KTE, corresponding to the description specified above. For this process the current position of the x-ray apparatus will be determined in relation to the 3D data set. The determination of the relative position can be determined by means of angle sensor units WG that are arranged at the x-ray source of the C-arm, for example. Not only points but also lines can be transferred to the location of the procedure on the patient O with the device. This embodiment is likewise an aid to the surgeon in that the incision lines can be established in an intraoperative imaging.

In a further embodiment, the laser of the optical source L can be used therapeutically in such a manner that laser incisions are made with the optical source L. For this use, the progression of the incision is marked in the 2D or 3D image and projected onto the patient. At least two orthogonal x-ray exposures are necessary for the implementation of the progression of the incision.

Although modifications and changes may be suggested by those skilled in the art, it is the intention of the inventor to embody within the patent warranted hereon all changes and modifications as reasonably and properly come within the scope of his contribution to the art.

I claim as my invention:

1. A device to align an optical unit with respect to an x-ray beam, comprising:
an x-ray source that emits an x-ray beam with which an x-ray image of a subject is acquired;
a processor configured to display said x-ray image and to allow manual interaction with said x-ray image to designate a marking location in said x-ray image;
an optical source that emits a light beam, said optical source having an optical source coordinate system associated therewith; and
a computerized coordinate transformation unit provided with information representing said marking location and information representing said optical source coordinate system, said coordinate transformation unit being configured to identify coordinates of said optical source, within said optical source coordinate system, that cause said optical source to emit said light beam to coincide with an x-ray beam traveling through said marking location on the subject, and to control said optical source to emit said light beam to visually identify said marking location at said subject.

2. A device as claimed in claim 1 wherein said optical source comprises a deflection unit that interacts with said light beam to deflect said light beam, and wherein said device comprises a control unit having access to said coordinate transformation unit, said control unit being configured to control operation of said deflection unit to deflect said light beam to visually indicate said marking location, dependent on an output supplied to said control unit from said coordinate transformation unit.

3. A device as claimed in claim 1 wherein said optical source is a laser unit that emits a laser beam as said light beam.

4. A device as claimed in claim 1 comprising an angle sensor unit configured to determine an angle of inclination of said x-ray source, said angle sensor unit emitting an output to said coordinate transformation unit.

5. A device as claimed in claim 1 wherein said x-ray source generates said x-ray image as a digital x-ray image, and wherein said device comprises an x-ray image data memory in which digital x-ray images generated by said x-ray source are stored, and from which the digital x-ray images are accessible by said coordinate transformation unit.

6. A device as claimed in claim 1 wherein said processor is configured to automatically identify said marking location in addition to said manual identification.

7. A device as claimed in claim 1 comprising an x-ray marker that indicates said marking location in said x-ray image.

8. A device as claimed in claim 1 comprising an electromagnetic navigation system configured to identify said marking location in said x-ray image.

9. A device as claimed in claim 1 wherein said optical source is configured to emit a light beam selected from the group consisting of a laser beam and an infrared beam.

10. A method to align an optical unit with respect to an x-ray beam, comprising:
from an x-ray source, emitting an x-ray beam with which an x-ray image of a subject is acquired;
at a processor, displaying said x-ray image and manually interacting with said x-ray image to designate a marking location in said x-ray image;
from an optical source, emitting a light beam, said optical source having an optical source coordinate system associated therewith; and
in a computerized coordinate transformation unit provided with information representing said marking location and information representing said optical source coordinate system, identifying coordinates of said optical source, within said optical source coordinate system, that cause said optical source to emit said light beam to coincide with an x-ray beam traveling through said marking location on the subject, and controlling said optical source to emit said light beam to visually identify said marking location at said subject.
